(19) United States
(12) Patent Application Publication
(10) Pub. No.: US 2019/0227163 A1
(43) Pub. Date: Jul. 25, 2019

(54) CLOUD-BASED AIRCRAFT SURVEILLANCE APPARATUS AND METHODS

(71) Applicant: Intersoft Electronics, Inc., McLean, VA (US)

(72) Inventor: Alexander E. Smith, McLean, VA (US)

(21) Appl. No.: 16/253,484

(22) Filed: Jan. 22, 2019

Related U.S. Application Data
(60) Provisional application No. 62/620,683, filed on Jan. 23, 2018.

(51) Int. Cl. G01S 13/91; G08G 5/00; G01S 13/72; H04L 29/08

(52) U.S. Cl. CPC G01S 13/91; H04L 67/10; G01S 13/726; G08G 5/0082

(57) ABSTRACT

A cloud-based aircraft surveillance system builds a database and a comprehensive picture of objects flying in a region by combining the surveillance from a number of individual radar systems. The acquired surveillance data supports missions including air traffic control, military, and homeland security. The object being tracked may be a passenger or commercial aircraft, military aircraft, or a drone. An improved method includes the steps of defining a sequence of adjoining virtual cells through which an object travels along a flight path within the airspace. Each virtual cell uses a different subset of the spaced-apart radar sensors, with the sensors being selected to optimize tracking geometry. Information associated with the tracking of the object may then be displayed for air traffic control and other purposes. Sensors may be selected in accordance with overall availability, dilution of precision (DOP), positional error, object identification, or to optimize back-up data.

### REFERENCE TO RELATED APPLICATIONS

This invention application claims priority to, and the benefit of, U.S. Provisional Patent Application Ser. No. 62/620,683, filed Jan. 23, 2018, the entire content of which is incorporated herein by reference.

### FIELD OF THE INVENTION

This invention relates generally to aircraft surveillance and, more particularly, to a cloud-based aircraft surveillance system that builds a surveillance picture by combining data from multiple radar systems.

### BACKGROUND OF THE INVENTION

Current air traffic control systems, to many extents, treat radars as separate, disparate sources of aircraft tracks which are then combined through some form of automation, using predominantly fixed networks. Individual radar systems currently output aircraft informational data in a serial form using a variety of formats, such as the Eurocontrol Standard Document for Surveillance Data Interchange, Category 048, incorporated herein by reference. As shown in FIG. 1, each individual aircraft tracked by the radar has a calculated Cartesian position (x,y) allowing the aircraft to be shown on a radar display for air traffic control or other purposes.

In the United States, individual radar systems used by the FAA use a series of networks known as the Flight Telecommunications Infrastructure (FTI), to route data to automation systems, as described by the FAA. See https://www.faa.gov/air_traffic/technology/cinp/fti/ and https://www.faa.gov/air_traffic/technology/cinp/fens/, incorporated herein by reference.

Additionally, the FAA has proposed some additional parameters for consideration in a definition of “coverage path” as described in Radar (SENSR) Program, SENSR Program: Overview, Presented by: Benjie Spencer Date: Mar. 26, 2018, incorporated herein by reference. FIGS. 8 and 9 are slides from that briefing, indicating that there are many attributes, including the lower and upper altitude (floor and ceiling), for a particular area.

Current automation systems process aircraft position reports for display on screens for air traffic controllers to guide and separate aircraft. Presently, air traffic control may use Automatic Dependent Surveillance (ADS-B), Secondary Surveillance Radar (SSR), and Primary Surveillance Radar (PSR). ADS-B relies on aircraft self-reporting of GPS-derived position while both SSR and PSR rely on target range and azimuth angle.

The performance requirements for many of the National Airspace System are detailed in FAA, Automatic Dependent Surveillance-Broadcast (ADS-B) Flight Inspection, National Policy 8200.45, Oct. 19, 2014, incorporated herein by reference.
14 CFR Part 91, Automatic Dependent Surveillance Broadcast (ADS-B) Out Performance Requirements to Support Air Traffic Control (ATC) Service; Final Rule. May 28, 2010.
Advisory Circular 20-165A; Airworthiness Approval of Automatic Dependent Surveillance-Broadcast (ADS-B) Out Systems. Nov. 7, 2012.
Advisory Circular 90-114, Change 1; Automatic Dependent Surveillance-Broadcast (ADS-B) Operations. Sep. 9, 2012.
Program Implementation Plan (PIP) for the Surveillance and Broadcast Services Program, PMO-002, Rev 01. Aug. 1, 2010.
RTCA DO-260B, Minimum Operational Performance Standards for 1090ES ADS-B and TIS-B. Dec. 2, 2009 © 2009, RTCA, Inc.
RTCA DO-282B, Minimum Operational Performance Standards for UAT ADS-B. Dec. 2, 2009 © 2009, RTCA, Inc.
Surveillance and Broadcast Services Description Document SRT-047, Revision 01. Oct. 24, 2011.

These parameters and requirements may be summarized as follows:
Separation, being the ability to accurately track airplanes separated by distances greater than 1 mile horizontally and 1000 feet vertically.
Track initiation, which is the ability to gain enough confidence in the initial, successive “radar hits” of a target to build a track.
Continuity is the successive updates to a track from periodic radar updates (nominally every 5 seconds in a terminal area or every 12 seconds en route).
Availability is the extent to which the system has the ability to operate when needed.
Resolution is a factor of overall accuracy and level of detail available.
Update rate, in this instance, is the composite update rate of surveillance information on a target when combining the various sources. Expected Performance is: Terminal update rate no greater than 3 seconds (PD of 95%), and en route update rate no greater than 6 seconds (PD of 95%).
Latency is the age of the information, which is required to be no greater than 0.7 seconds for the new ADS-B surveillance service.

A single SSR or PSR sensor can provide aircraft 2D position; however, it is possible to use multiple radar sensors to provide a more accurate position than a single sensor. This process is a variation of triangulation, combining angular and range measurement from 3 sensors. For more than 3 sensors, the process is essentially a variation of multilateration.

In other architectures, combinations of radar signals are referred to as “Netted Radar.” See H. Deng, “Orthogonal netted radar systems,” in IEEE Aerospace and Electronic Systems Magazine, vol. 27, no. 5, pp. 28-35, May 2012. doi: 10.1109/MAES.2012.6226692; and C. J. Baker and A. L. Hume, “Netted radar sensing,” in IEEE Aerospace and Electronic Systems Magazine, vol. 18, no. 2, pp. 3-6, February 2003. doi: 10.1109/MAES.2003.1183861, both references being incorporated herein by reference.

A cellular network radar approach, using groups of (generally) 3 sensors for radar positioning, is described in Intersoft Electronics Cellular Network Radar, An Advanced Technology Solution, dated 2 Mar. 2017, incorporated herein by reference. This approach contemplates individual radar cells constructed as generally shown in FIG. 2. In this example, and in all embodiments described herein, it is presumed that the sensors are in communication with one another through a communications network or infrastructure 160, which may be implemented with any technology or combinations thereof, including high-speed wired, microwave, RF or optical interconnections. It is further presumed that the network is in communication with one or more processors 170 and/or radar displays 180 for air traffic control, and wherein the processor(s) and control facilities may or not be co-resident.

Continuing the reference to FIG. 2, cell 150 comprises three radar sensors 120, 130, 140, tracking the aircraft 110, with an ideal or optimum dilution of precision (DOP). DOP, described in U.S. Pat. No. 7,132,982, “Method and Apparatus for Accurate Aircraft and Vehicle Tracking,” incorporated herein by reference, effectively increases the error in a position measurement when the target is in positions of poor geometry with respect to the radar locations. In FIG. 2, the DOP is ideal or optimum because at the instantaneous position shown, aircraft 110 is more or less equidistant from the three sensors 120, 130, 140, such that the combination of angular and range measurements is readily and accurately computed using processor(s) 170.

An example of poor geometry is shown in FIG. 3. Here, cell 250 comprises 3 radar sensors 220, 230, 240 which have a poor geometry with respect to the aircraft 210. In FIG. 4, aircraft 20, 30, 40 are shown moving through adjacent conventional radar cells 10. As the aircraft transits through the cells it moves from high DOP at position 20 to low DOP at position 30 and back to high DOP at position 40. This means that the positional error as a result of multilaterating varies dramatically as the aircraft transits through the cells.

Due to these and other deficiencies, there is an outstanding need for an improved aircraft sensing architecture that is not bound by the constraints of predetermined cell size, shape or position.

### SUMMARY OF THE INVENTION

The present invention is a cloud-based aircraft surveillance system that builds a database and complete surveillance picture of aircraft flying in a region by combining the surveillance from a number of individual radar systems. By taking a cloud-based approach, the invention allows for a “big data” method to track and identify aircraft and other objects, which can then be used to support a variety of enterprise applications.

The comprehensive dataset of surveillance data made possible by the invention supports a variety of enterprise applications offering more complete, accurate information to support many different missions including air traffic control, military, and homeland security. The object being tracked may be a passenger or commercial aircraft, military aircraft, or a drone.

The improved surveillance method is applicable to an airspace wherein multiple, spaced-apart radar sensors are used to track aircraft and other objects. A preferred embodiment includes the steps of defining a sequence of adjoining virtual cells through which an object travels along a flight path within the airspace. Each virtual cell uses a different subset of the spaced-apart radar sensors, with the sensors being selected to optimize tracking geometry. Information associated with the tracking of the object may then be displayed for air traffic control and other purposes. The method may include the step of determining the initial position of the object when it enters the airspace.

The sensors may be selected in accordance with various criteria. For example, the sensors may be selected to optimize dilution of precision (DOP), to minimize object positional error, to maximize correct object identification, or to optimize back-up data associated with the object. Sensor selection may also be based upon sensor availability in general.

The size of a virtual cell may be based upon the operational demand of the spaced-apart radar sensors. For example, the virtual cells in high-density airspaces may be smaller than virtual cells associated with lower-density airspaces.

The method may include the steps of building a database including information associated with sensor selection, and searching the database to determine sensor performance, accuracy, or loading. The database may also be queried to generate a sensor usage report, and/or to determine fees or billing based upon usage.

### BRIEF DESCRIPTION OF THE DRAWINGS

FIG. 1 is a table that lists Radar Output ASTERIX Data in accordance with the Eurocontrol Standard Document for Surveillance Data Interchange, Category 048,

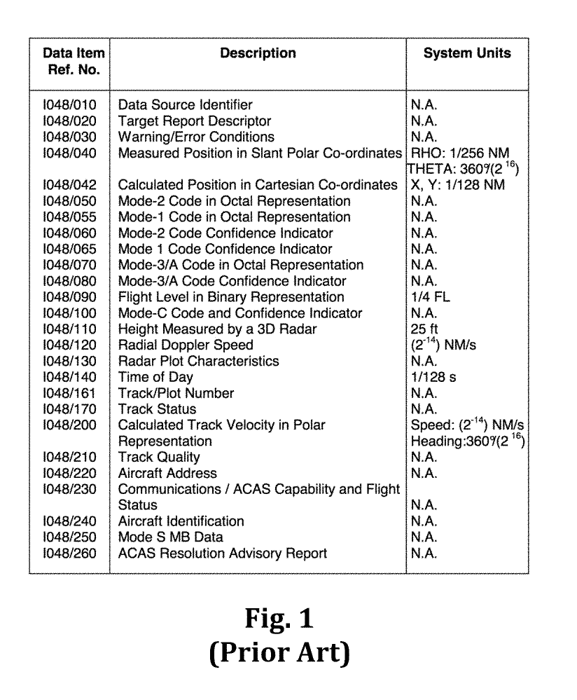

FIG. 2 illustrates a Cellular Network Radar exhibiting a High Dilution of Precision;

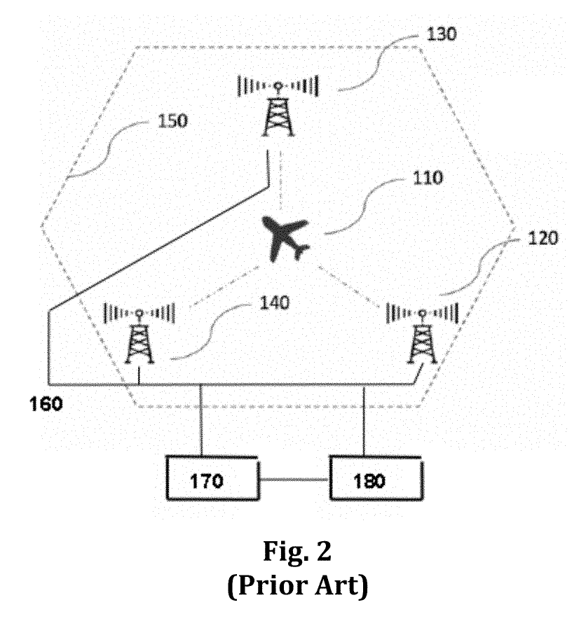

FIG. 3 illustrates a Cellular Network Radar with Low Dilution of Precision;

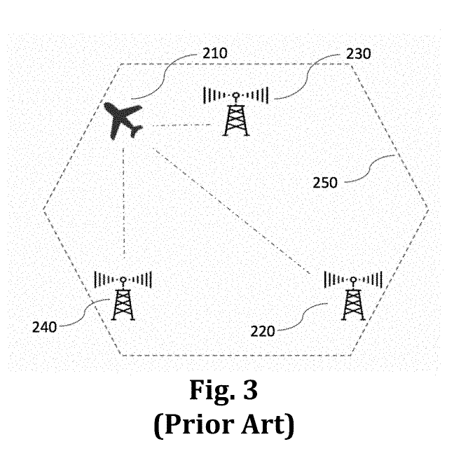

FIG. 4 shows an Aircraft Transiting Through Fixed Radar Network Cells Varying Dilution of Precision;

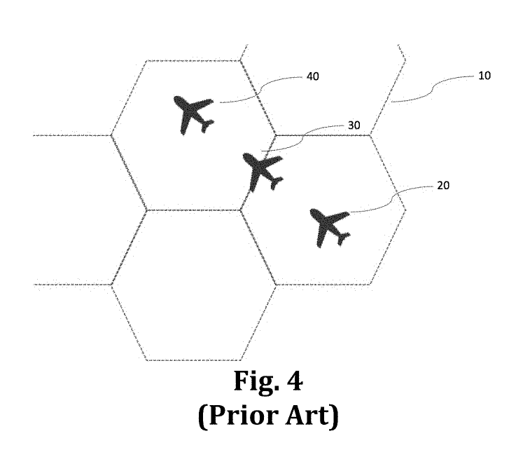

FIG. 5 is a diagram that shows high-density airspace, as might be found in major metropolitan areas, and a lower-density airspace, as one would find in the less inhabited parts of the country;

FIG. 6 illustrates a preferred embodiment including aircraft tracking, sensor self-checking, and sensor usage monitoring applications;

FIG. 7 is a flow and state diagram that illustrates steps and capabilities associated with a method according to the invention;

FIG. 8 is a slide from the FAA Radar (SENSR) Program providing CV Path Definitions; and

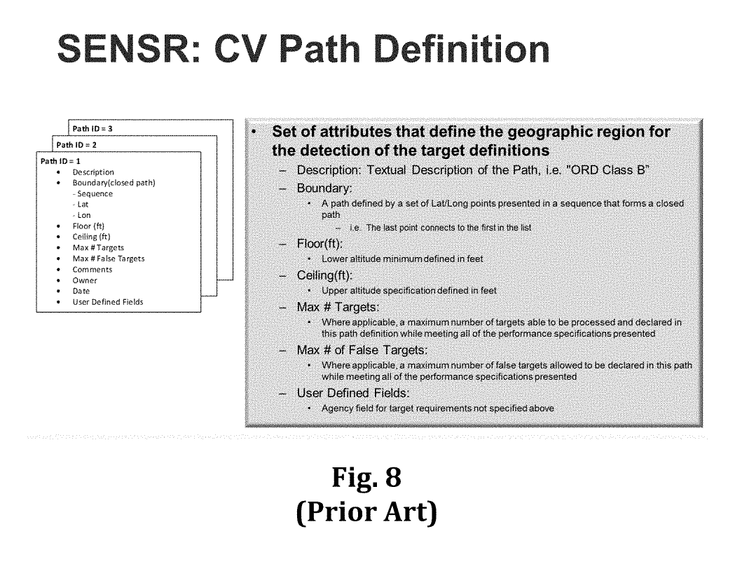

FIG. 9 is a slide from the FAA Radar (SENSR) Program defining Global CV Attributes.

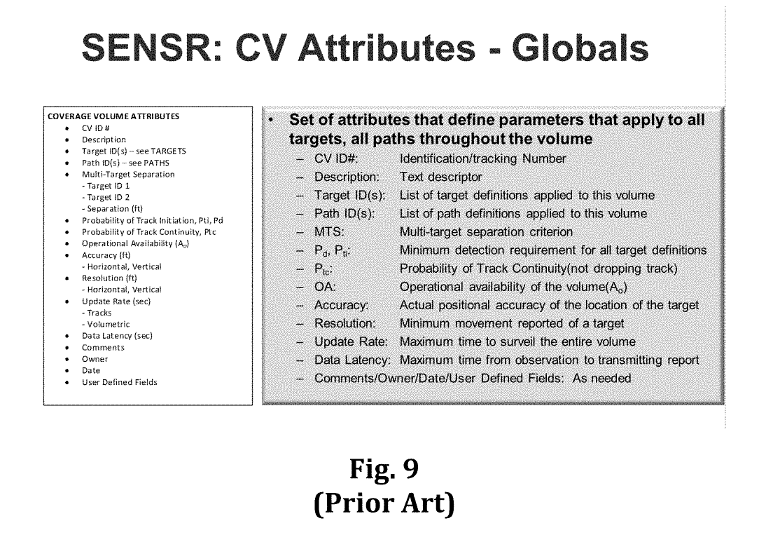

### DETAILED DESCRIPTION OF THE PREFERRED EMBODIMENTS

The present invention is a cloud-based aircraft surveillance system that builds a database and complete surveillance picture of aircraft flying in a region by combining the surveillance from a number of individual radar systems. By taking a cloud-based approach, the invention allows for a “big data” method to track and identify aircraft and other objects, which can then be used to support a variety of enterprise applications.

As defined by the Cloud Standards Customer Council in May 2014, incorporated herein by reference, and presented at http://www.cloud-council.org/deliverables/CSCC-Deploying-Big-Data-Analytics-Applications-to-the-Cloud-Roadmap-for-Success.pdf, “Big Data focuses on achieving deep business value from deployment of advanced analytics and trustworthy data at Internet scales.”

The comprehensive dataset of surveillance data made possible by the invention supports a variety of enterprise applications offering more complete, accurate information finding utility in many different missions, including air traffic control, military, and homeland security. As defined in Federation of EA Professional Organizations, Common Perspectives on Enterprise Architecture, Architecture and Governance Magazine, Issue 9-4, November 2013,” incorporated herein by reference, Enterprise Architecture is “a well-defined practice for conducting enterprise analysis, design, planning, and implementation, using a comprehensive approach at all times, for the successful development and execution of strategy. Enterprise architecture applies architecture principles and practices to guide organizations through the business, information, process, and technology changes necessary to execute their strategies.”

Through the use of a cloud-based, enterprise architecture, the apparatus and methods disclosed herein minimize and often prevent variations in positional error by varying the selection of sensors to be used in determining position. This can be achieved by selecting sensors that offer the better geometry as well as other factors. It is also possible to “over-determine” the aircraft position in a manner similar to that of GPS navigation, as described in http://www.gpsinformation.org/dale/theory.htm and https://play.google.com/store/apps/details?id=com.tananaev.celltowerradar, incorporated herein by reference.

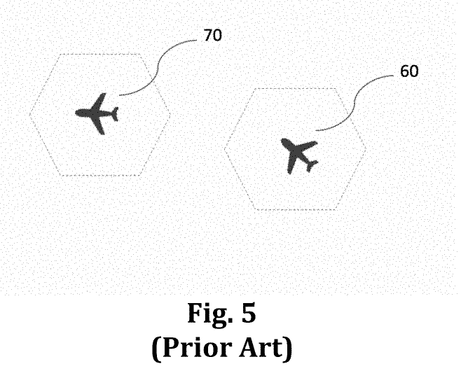

In a preferred embodiment, shown in FIG. 5, the aircraft transits 60, 70 through airspace defined by virtual cells, which are areas computed to present an optimal solution based on a selection of nearby sensors, while other radar sensors may be individually tasked for security or military applications.

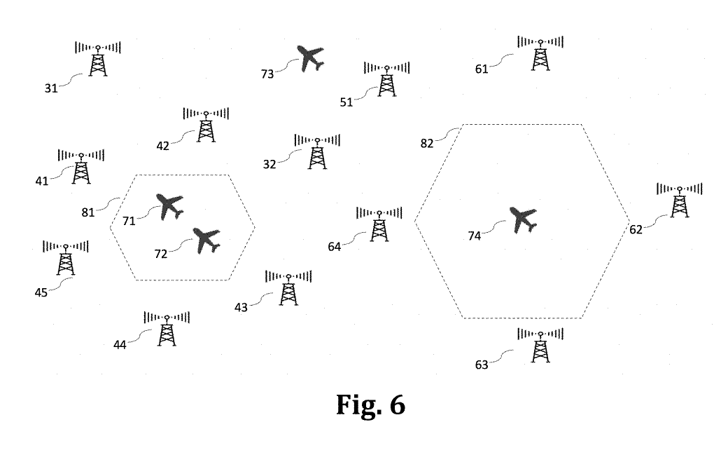

An example of airspace is shown FIG. 6. The two aircraft 71, 72, represent aircraft in high-density airspace as might be found in major metropolitan areas, whereas aircraft 74 is in a lower-density airspace, as one would find in the less inhabited parts of the country. In this example, suitable sensors are selected for optimal DOP and/or other factors, including minimizing positional error, maximizing correct identification, and/or optimizing back-up data that may be required (x, y, z, call sign, Mode S). The difference between the high-density and low-density airspace is predominantly sensor and network loading, which translates to size of the virtual cell. As such, virtual cell 81 in the high-density airspace, which uses sensors 41, 42, 43, 44, 45, is typically smaller in scale than the low-density airspace virtual cell 82 that uses sensors 61, 62, 63, 64.

In the example of FIG. 6, sensors 31 and 32 are not used for tracking, or they may be unavailable for technical or other reasons. Sensor 51 is dedicated to tracking target 73, which could be the case for military or homeland security tracking and could be, for example, a small drone that the security services have interest in tracking.

Another application using the data includes assessment of surveillance sensor usage; i.e., which sensors are most and least used for surveillance by air traffic control or other functions such as homeland security or military usage, which could be useful for maintenance or fee-for-use structures. Other applications include the ability to self-correct or identify those sensors that may be operating out of tolerance, close to out of tolerance, or trend information.

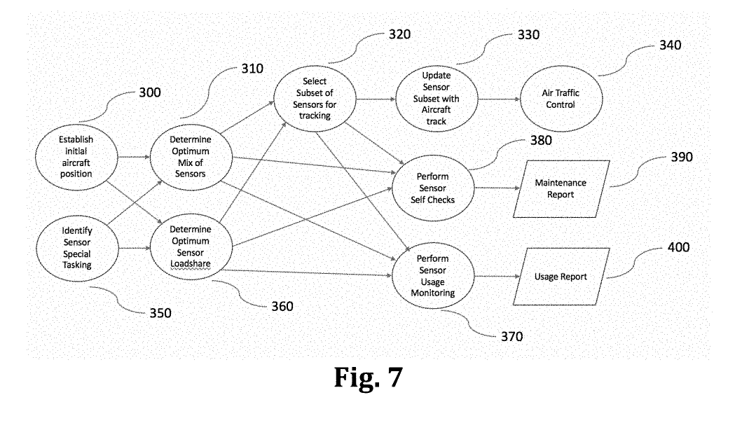

FIG. 7 is a flow and state diagram that illustrates steps used in a method according to the invention. At least three applications are supported, including aircraft tracking, sensor self-checking, and sensor usage monitoring. At the left in the diagram, an aircraft 300 enters the area of sensors and an optimum subset of sensors is selected 310. That optimum set of sensors is based on geometry and other factors such as whether some sensors are unavailable due to special tasking 350. For example, special tasking could dictate the exclusive use of certain sensors to track and identify a single specific target, such as an errant drone.

Once the target subset is identified 320, the aircraft is tracked at 330, and tracking information is presented to air traffic control on various displays 340. Using the target of interest 300, and the optimum mix of sensors 310 as well as the subset being used 320, it is possible to check the accuracy and other performance attributes of individual sensors 380. Further, by using the highest confidence source(s), it is possible to assess the performance attributes and tolerances of the other sensors and to generate a maintenance report at 390.

It is also possible to determine overall sensor loading 360, and monitor overall sensor usage 370, so as to generate a usage report 400. Such a report may have multiple purposes, including criticality analyses and architectural redundancy estimation, as well as billing and fee management.

1. In an airspace wherein multiple, spaced-apart radar sensors are used to track aircraft and other objects, an improved surveillance method, comprising the steps of:
defining a sequence of adjoining virtual cells through which an object travels along a flight path within the airspace;
wherein each virtual cell uses a different subset of the spaced-apart radar sensors, and wherein the sensors are selected to optimize tracking geometry; and
displaying information associated with the tracking of the object for air traffic control purposes.

2. The method of claim 1, including the sensors selected to optimize dilution of precision (DOP).

3. The method of claim 1, including the sensors selected to minimize object positional error.

4. The method of claim 1, including the sensors selected to maximize correct object identification.

5. The method of claim 1, including the sensors selected to optimize back-up data associated with the object.

6. The method of claim 1, including virtual cells that have a size based upon the operational demand of the spaced-apart radar sensors.

7. The method of claim 6, wherein the virtual cells in high-density airspaces are smaller than virtual cells associated with lower-density airspaces.

8. The method of claim 1, including the step of building a database including information associated with sensor selection.

9. The method of claim 8, including the step of searching the database to determine sensor performance or accuracy.

10. The method of claim 8, including the step of searching the database to determine sensor loading.

11. The method of claim 8, including the step of searching the database to generate a sensor usage report.

12. The method of claim 11, including the step of determining fees and billing based upon usage.

13. The method of claim 1, wherein sensor selection is also based upon sensor availability.

14. The method of claim 1, including the step of determining the initial position of the object when it enters the airspace.

15. The method of claim 1, wherein the object is a passenger or commercial aircraft, military aircraft, or a drone.
